(19) United States
(12) Patent Application Publication
(10) Pub. No.: US 2004/0015876 A1
(43) Pub. Date: Jan. 22, 2004

(54) Method and structure of implementing a safe pointer

(76) Inventor: John R. Applin, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/864,439

(22) Filed: May 24, 2001

(51) Int. Cl. G06F 9/44

(52) U.S. Cl. 717/127; 717/128

(57) ABSTRACT

The present invention is directed to a transparent method of correctly handling improper use of pointers. During the execution of programs, pointers are occasionally returned to the program and, if treated improperly, may adversely effect system operation resulting in termination of the program, a nonresponsive system or invalid or erroneous results. The present invention defines a safe pointer which supports standard pointer operations and performs pointer checking on each pointer returned to the executing program to determine whether its use is consistent with the pointer type. If the operation will not cause any error, the operation is allowed. If the operation will cause an error or other to undesirable operation, the operation is not permitted to be performed on the pointer and appropriate actions are taken.

### BACKGROUND

In computer programming, pointers are used as variables that contain the memory location, or address, of data rather than the data itself. The use of pointers allows the memory used for the data to be dynamically allocated and provides additional flexibility in the maintenance of the data. In many computer languages pointers to the information are dynamically created, memory space for the pointed-to-variable allocated, and the active pointer returned, rather than returning the data itself. A “null pointer” may be created if a memory allocation fails, if a memory allocation is invalid or if there are no values for the pointer to point to. A “null pointer” is a special pointer which, literally, points to nothing.

More, generally, if the information is unavailable a null pointer, sometimes referred to as a nil pointer, is returned. A null pointer is literally a pointer to nothing, which implies that the data requested does not exist. The null pointer usually indicates that a data search operation has come up empty handed.

As described, a null pointer is a special pointer which indicates the lack of data, rather than pointing to specific data. The null pointer typically cannot be used as a regular pointer would be used. Attempting to use a null pointer as a normal pointer may cause unpredictable results in the computer system. These unpredictable results may include halting the computer system, causing the system to become nonresponsive, or producing invalid or erroneous results. Programmers using good programming practice often include special code to check for null pointers in order to prevent these error conditions from occurring. When programs include software to recognize and react appropriately to an improper use of a null pointer, the presence of a null pointer does not adversely effect system operation. However, problems arise in the presence of null pointers when programmers do not check for the presence of the null pointer and treat the null pointer as if it were a normal pointer.

In the prior art, environments exist which oversee the running of computer programs. For example, a programmer could take a C++ program and run it in a Purify environment.

Purify is a run-time memory checker available from Rational Technology designed to track down memory leaks and invalid memory use. One of the functions of Purify is to ensure that null pointers are not used inappropriately. Purify would therefore check pointers before their use and if a program tried to use a null pointer inappropriately, Purify would send a message to the programmer which indicated the misuse of the null pointer. In order to take advantage of these safeguards, the programmer must run their program within the environment of the overseeing program. This typically requires additional steps and results in an increased overhead dedicated to the overseeing program. Both memory and CPU cycles are consumed by the Purify program and the resulting environment.

Similarly, misuse of other pointers may also cause unpredictable results including halting the computer program, causing the system to become nonresponsive or producing invalid or erroneous results. This misuse may include pointers improperly aligned for the type of data retrieved and other inconsistent pointer usage problems.

### SUMMARY OF THE INVENTION

The present invention includes a system and method that create a “safepointer” construct which is used, for example, by a function, subroutine, or a global variable, to provide information or data to a calling routine, initializing code segment, or other object that is to use a pointer provided by another object. The “safepointer” encapsulates a native pointer within an object that provides automatic pointer checking to detect and avoid or minimize misuse of a pointer. Examples of such misuse include an attempt to use a null pointer to access data, and use of a pointer to an integer value to retrieve a real number.

The invention includes a method of storing and manipulating pointers in a programming language where the programming language supports a native pointer type and standard pointer operations. The method includes defining a safe pointer type which supports the standard pointer operations, performs additional automatic pointer checking and use of the safe pointer type.

Another embodiment of the present invention includes a safe pointer class which supports both the storage of, and manipulation of, a pointer in a programming language where the programming language supports a native pointer type and standard pointer operations. In this embodiment, the safe pointer type supports standard pointer operations and automatic pointer checking.

Another embodiment of the present invention includes a computer program product recorded on a computer readable medium for reducing a likelihood of misuse of pointers upon which at least one software application is running. In this embodiment, the computer program includes means for defining a safe pointer type, supporting a standard pointer operation and performing automatic pointer checking.

### BRIEF DESCRIPTION OF THE DRAWINGS

FIG. 1 is a flow diagram of a program which checks for a null pointer and, if the null pointer is present, appropriately handles the null pointer;

FIG. 2 is an operation code which illustrates one embodiment of the present invention; and

FIG. 3 illustrates a computer system adapted to use the present invention.

### DETAILED DESCRIPTION

A need therefore exists for a method of testing for improper pointer usage which is transparent to the user, does not result in increasing the resources required to run the program, and allows a graceful reaction to the misuse when it is present. A further need exists for this method to be virtually transparent to the programmer in terms of memory required and in system resources required to implement the misuse handling routine.

The present invention is applicable to a wide range of checks to verify proper pointer usage and initiate any appropriate processing to avoid a fatal error, execution of an invalid operation, and/or provide notification of an error, warning or other condition. Thus, the invention contemplates checking for, by way of example, null pointers, pointers not properly aligned for the type of data to be retrieved (i.e., misaligned pointers), and other pointer usage inconsistent with a particular operation, data type, etc. The invention further contemplates a wide range of possible processing if a misuse or potential misuse is detected including, for example, terminating program execution and generating an error message, providing a warning message without terminating program execution, providing alternative processing and/or default values in response to identification of a pointer problem without program termination, etc.

Flow chart 100 of FIG. 1 is a simplified flow diagram of a method of checking for null pointer, or other pointer, misuse and handling such conditions according to the present invention. For purposes of the present illustration, at step 101 the pointer available for use is examined to determine if the pointer is equal to the null or nil pointer. As previously detailed, other pointer conditions may also be checked, such as pointer misalignment relative to the type of data associated with the pointer (e.g., real, integer, character, pointer, etc.). An alignment check may include checking the type of data or object pointed to and ensuring the address is consistent with the data or object type. If the pointer is not equal to a nil or a null pointer, the pointer is used as desired by the user's program in step 102. If, however, the pointer being examined in step 101 is equal to the null pointer a message is sent to the user (not shown) in step 103 which informs the user that an invalid operation was attempted to be performed on the null pointer. Once this message is displayed to the user, step 104, in one embodiment of the invention, ensures that the execution of the affected operation is halted in step 104. Once execution of the operation has been halted in step 104, it may be desirable for execution of the program to be terminated or for the program to continue with reduced functionality. In step 105 the desired next step is determined by the system. For some programs it will be entirely acceptable for the system to wait for the user to correct the inappropriate use of the null pointer before execution of the program is continued. In time critical applications, it would be unacceptable for execution of the program to be halted until the program is fixed. In these cases, a safe or recovery state must be identified and programmed into the system for instantiation when an inappropriate use of the null pointer is attempted. In either event, step 106 initiates the desired action.

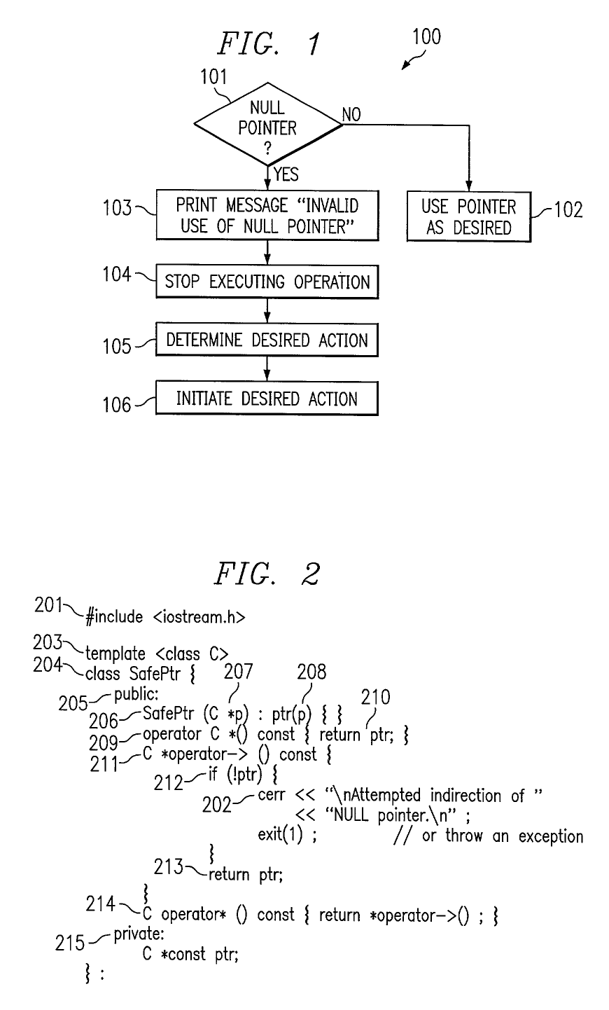

FIG. 2 is an embodiment of the current invention implemented as a pointer template class in C++. Statement 201 ensures that I/O stream software is available for output stream 202 which is used to store error messages. Template class 203 declares a template class and contains the parameter called C. In C++, a template class is a parameterized class. The template class includes variability and requires an argument to be specified in order to use the class. The included arguments modify the behavior of the template class. During compilation the arguments are used to define the functionality of the class. Class SafePtr 204 defines a class comprising of a public and private portions. The public portion of class SafePtr is visible to any user of the class SafePtr. The private portion of the class is for the private use of the class itself. The public portion of class 205 includes a constructor for SafePtr 206. The public portion describes how the safe pointer itself is created. Argument list 207 in constructor 206 contains the arguments to the constructor including a pointer designated as p. The “C” in argument list 207 indicates that p points to an object of type C where C is the template parameter. The member initialization list 208 initializes the private member pointer to the argument p. Effectively, the constructor receives a pointer and stores the pointer in a private variable called “ptr.”

Member function 209 is a conversion function. The conversion function is used to convert the safe pointer to a pointer to C. If the specific pointer was requested as shown at reference 210, error checking is assumed to be performed on the pointer before it is used.

Line 211 shows where the program which has called the pointer is trying to use the pointer without checking the pointer to ensure it is not a null pointer. In line 212, a check is performed to test for a null pointer so that error or exception processing may be invoked. If the pointer is equal to a null pointer, the program is exited and a warning or similar message is displayed to the user. If the pointer is not equal to the null pointer, the pointer is returned to the user in line 213. Line 214 reuses the portion of the code discussed previously which checks to ensure that the pointer being used is not a null pointer. Line 215 begins the private portion of the class. The private portion of the class consists of a private copy of the pointer to the real thing or the null pointer which the user's program desires access to.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, and erasable ROM (EROM), a floppy diskette, a compact disk CD-ROM, an optical disk, a hard disk, etc., while transmission media may include, for example, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, an intranet, etc.

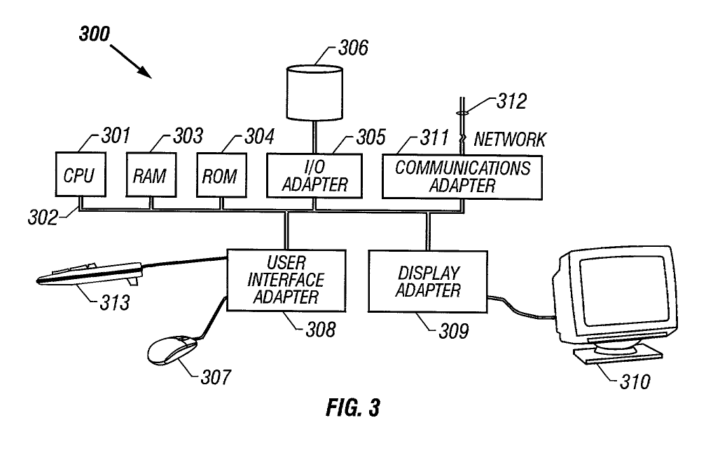

FIG. 3 illustrates computer system 300 adapted to use the present invention.

Central Processing Unit (CPU) 301 is coupled to system bus 302. The CPU 301 may be any general purpose CPU, such as an HP PA-8500 or Intel Pentium processor. However, the present invention is not restricted by the architecture of CPU 301 as long as CPU 301 supports the inventive operations as described herein. System bus 302 is coupled to Random Access Memory (RAM) 303, which may be SRAM, DRAM or SDRAM. ROM 304 is also coupled to system bus 302, which may be PROM, EPROM, or EEPROM. RAM 303 and ROM 304 hold user and system data and programs as is well known in the art.

System bus 302 is also coupled to input/output (I/O) controller card 305, communications adapter card 311, user interface card 308, and display card 309. The I/O card 305 connects to storage devices 306, such as one or more of a hard drive, a CD drive, a floppy disk drive, a tape drive, to the computer system. Communications card 311 is adapted to couple the computer system 300 to a network 312, which may be one or more of a telephone network, a Local (LAN) and/or a Wide-Area (WAN) network, an Ethernet network, and/or the Internet network and can be wire line or wireless. User interface card 308 couples user input devices, such as keyboard 313 and pointing device 307, to computer system 300. Display card 309 is driven by CPU 301 to control display device 310.

What is claimed is:

1. A method for storing and manipulating pointers in a programming language, wherein the programming language supports a native pointer type and standard pointer operations upon a native pointer object of said native pointer type, said method comprising the step of:
defining a safe pointer type supporting said standard pointer operations; and
performing automatic pointer checking in association with safe pointer type.

2. The method of claim 1 wherein said automatic pointer checking includes checking for a null pointer.

3. The method of claim 1 wherein said automatic pointer checking includes checking for improper pointer alignment.

4. The method of claim 1 further comprising a step of performing error processing.

5. The method of claim 4 wherein said error processing includes at least one of generating an error message and terminating program execution; generating a warning message without terminating program execution; and invoking a user defined error processing routine.

6. The method of claim 1 further comprising the steps of:
calling a function which returns as its value an object of said safe pointer type; and
performing said standard pointer operations upon said object.

7. The method of claim 1 further comprising the steps of:
reading a global variable of said safe pointer type; and
performing said standard pointer operation upon said object.

8. The method of claim 1 further comprising the steps of:
calling a function which returns as its value an object of said safe pointer type, said object encapsulating an improper native pointer object; and
performing error processing in response to said improper native pointer object.

9. The method of claim 1 wherein said improper native pointer object comprises one of a null pointer, misaligned pointer, and misuse of said pointer in context.

10. The method of claim 1 further comprising the steps of:
reading a global variable encapsulating an improper native pointer object; and
performing error processing in response to said improper native pointer object.

11. A safe pointer class supporting both the storage of and manipulation of a pointer in a programming language, the programming language supporting a native pointer type and standard pointer operations upon a native pointer object of said native pointer type, said safe pointer class comprising:
a safe pointer type configured to support said standard pointer operations; and
said safe pointer type further configured to support automatic pointer checking.

12. The safe pointer class of claim 11 wherein said automatic pointer checking includes checking for a null pointer.

13. The safe pointer class of claim 11 wherein said automatic pointer checking includes checking for improper pointer alignment.

14. The safe pointer class of claim 11 further comprising:
an error processing routine.

15. The safe pointer class of claim 14 wherein said error processing routine includes at least one of an error message generator and a program execution terminator; warning message generator with program execution continuer; and a user defined error processing routine.

16. The safe pointer class of claim 11 wherein said improper native pointer object comprises one of a null pointer, misaligned pointer, and misuse of said pointer in context.

17. A computer program product recorded on computer readable medium for reducing a likelihood of misuse of pointers upon which at least one software application is running, said product comprising:
computer readable means for defining a safe pointer type;
said computer readable means supporting standard pointer operations; and
said computer readable means performing automatic pointer checking.

18. The program product as claimed in claim 17 wherein said automatic pointer checking includes checking for a null pointer.

19. The program product as claimed in claim 17 wherein said automatic pointer checking includes checking for improper pointer alignment.

20. The program product as claimed in claim 17 further comprising:
computer readable means for performing error processing.
